(19) United States
(12) Patent Application Publication
(10) Pub. No.: US 2004/0177000 A1
(43) Pub. Date: Sep. 9, 2004

(54) Information processing apparatus and printing cost returning method

(76) Inventor: Kouichi Takamine, Hyogo (JP)

Correspondence Address: McDermott Will & Emery, 600 13th Street NW, Washington, DC, 20005-3096, US

(21) Appl. No.: 10/485,956

(22) PCT Filed: Jul. 26, 2002
(86) PCT No.: PCT/JP02/07652

(30) Foreign Application Priority Data
Aug. 7, 2001 (JP) 2001-239848

(51) Int. Cl. G06F 17/60

(52) U.S. Cl. 705/14

(57) ABSTRACT

The invention has an object to make the advertisement provided through the Internet print actively. The content stored in the client is combined with the advertisement data stored in the server. When the combined data is printed by the information processing apparatus included in the local system of the client, the fee reduction point is given to the client according to the number of the printing sheets. When the fee reduction points become a specific value, the consumption good for the printing is provided to the user included in the local system. The invention adopts the method of reducing the printing fee by incorporating the advertisement into the printed matters, in such way. Therefore, the advertisement provided through the Internet is printed out actively.

### TECHNICAL FIELD

The invention relates to a method for reducing the printing fee by incorporating an advertisement into a printed matter.

### BACKGROUND ART

In these days, along with the advance of the digital technology and the network technology, people give much attention to the banner advertising for linking from advertisement image on a Website to an advertiser's Website, and the mail advertising of the E-mail magazine publishing the advertisement of an advertiser's Website.

In case of the banner advertising, the accounting system adopts a method of computing per display of the image (the impression guaranteed advertisement), a method of computing per actual click of user (the click guaranteed advertisement), a method of computing for the number of cases when the contract is concluded through the advertiser's Website (the customer action advertisement), and so on.

In comparison of the conventional advertising for distributing printed matters, the above-mentioned advertising through the Internet has a merit that the publicity can be raised widely and economically in real time. On the other hand, the conventional advertising for distributing printed matters has been utilized still now, due to the availability of the printed matter that everyone keeping the printed matter in hand can read it at any time.

But, in case of the advertisement provided through the Internet, the cost of printing sheets and marking materials must be charged to the user in order to print the advertisement. Therefore, it is general that the Internet advertisement is hardly printed out at all. And it is nevertheless to say that such tendency becomes notable in matters of home particularly.

The present invention is suggested considering the above-mentioned problems and has an object to lead that a user is willing to print the advertisement provided through the Internet.

### DISCLOSURE OF INVENTION

The invention adopts following means to achieve the above object.

The content stored in a client is combined with advertisement data stored in a server. When the combined data is printed out by an information processing apparatus included in a local system of the client, a fee reduction point is given to the client according to the number of printing sheets. When the fee reduction points become a specific value, a consumable good for the printing is provided to a user included in the local system.

In such way, the invention adopts the method of reducing the printing fee by incorporating the advertisement into the printed matter. And hereupon, it is sure that the advertisement provide through the Internet is printed out actively.

Moreover, the invention can combine the advertisement data to the content stored in the client, too. And this can increase the user's willingness of printing the advertisement, so that the advertisement provided through the Internet could be printed actively.

In addition, the fee reduction point may be given to the client according to the number of advertisement data in the combined data instead of the number of printing sheets. According to this configuration, even when a plurality of advertisement data is combined on one sheet, the fee reduction point can be given properly.

### BRIEF DESCRIPTION OF DRAWINGS

FIG. 1 is a diagram schematically showing a configuration of the printing fee reduction system in the first embodiment.

FIG. 2 is a diagram showing main components of the printing fee reduction system in the first embodiment.

FIG. 3 is a diagram showing a processing flow of the printing fee reduction system in the first embodiment.

FIG. 4 is a diagram schematically showing a configuration of the printing fee reduction system in the second embodiment.

FIG. 5 is a diagram showing main components of the printing fee reduction system in the second embodiment.

FIG. 6 is a diagram showing a processing flow of the printing fee reduction system in the second embodiment

FIG. 7 is a diagram showing main components of another printing fee reduction system in the second embodiment.

FIG. 8 is a diagram schematically showing a configuration of the printing fee reduction system in the third embodiment.

FIG. 9 is a diagram showing main components of the printing fee reduction system in the third embodiment.

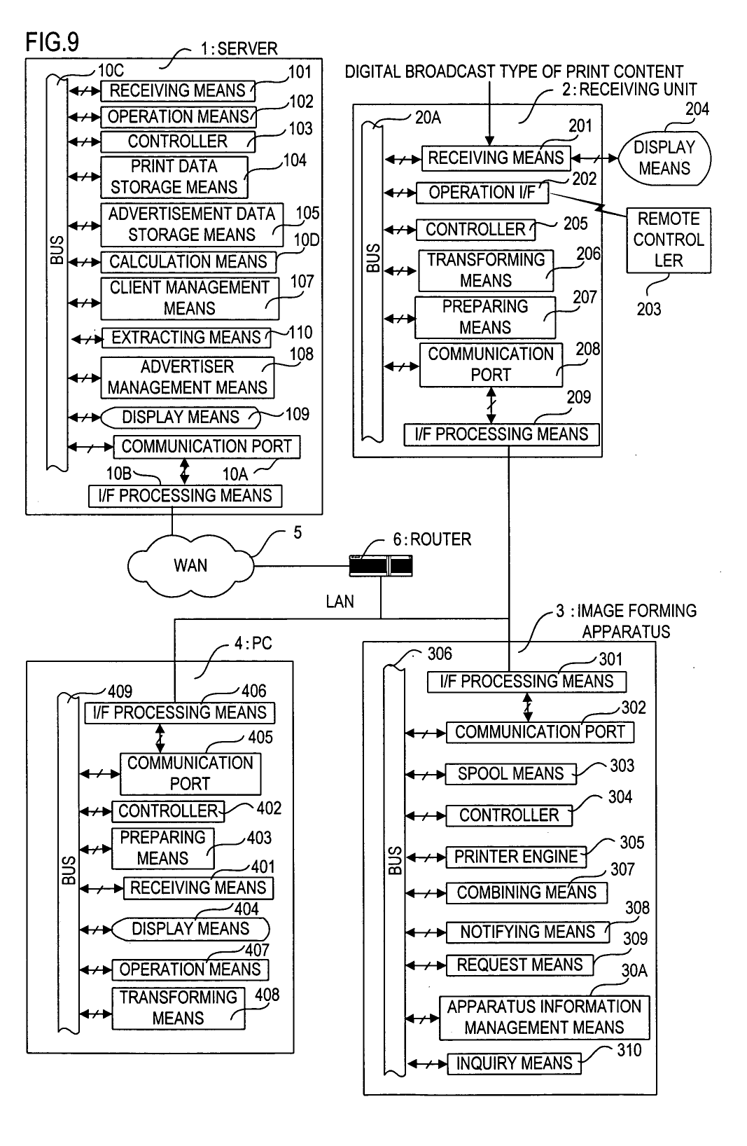

FIG. 10 is a diagram showing a processing flow of the printing fee reduction system in the third embodiment.

FIG. 11 is a diagram showing an example of combining an advertisement data with a main print data.

FIG. 12 is a diagram showing an example of combining an advertisement data with a main print data.

FIG. 13 is a diagram schematically showing a configuration of the printing fee reduction system in the fifth embodiment.

FIG. 14 is a diagram showing main components of the printing fee reduction system in the fifth embodiment.

FIG. 15 is a diagram of showing a digital television for displaying an advertisement data.

FIG. 16 is a diagram schematically showing a configuration of the printing fee reduction system in the sixth embodiment.

FIG. 17 is a diagram showing a processing flow of the printing fee reduction system in the sixth embodiment.

### BEST MODE FOR CARRYING OUT THE INVENTION

Here is described in details the preferred embodiments of the invention according to the drawings.

### Embodiment 1

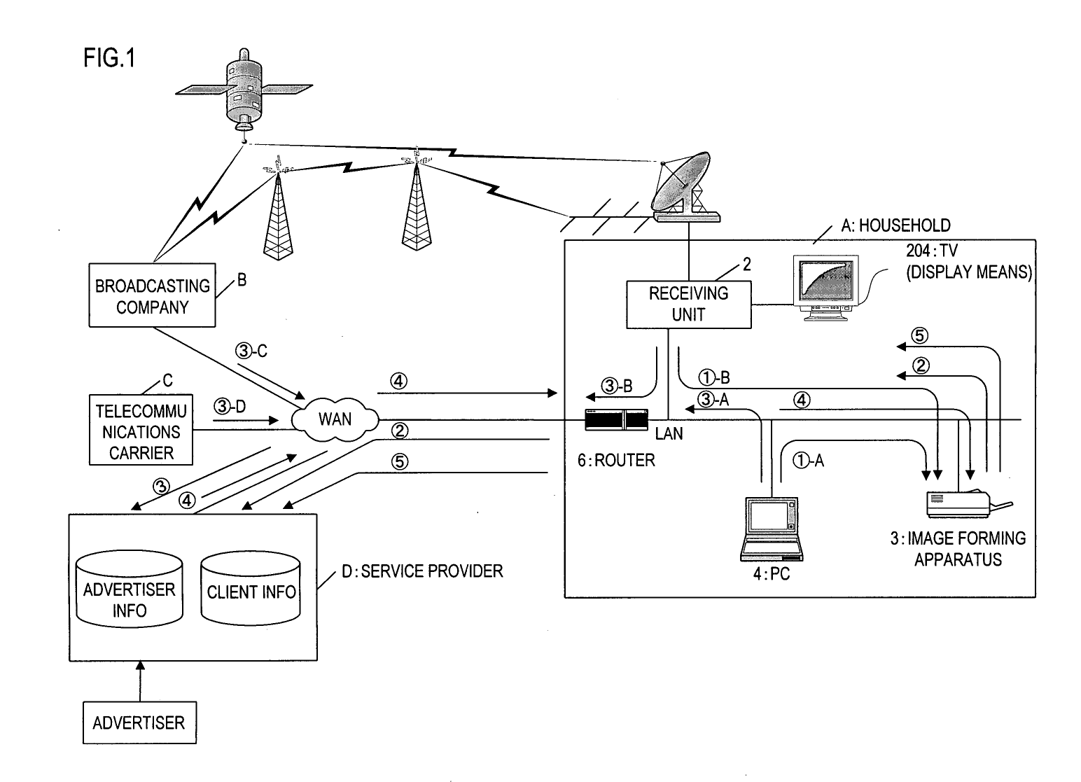

FIG. 1 is a diagram schematically showing a configuration of the printing fee reduction system in this embodiment.

A service provider D is to provide a service for reducing the printing fee. A server provided by the service provider D can carry out such service, of which configuration will be explained in details later.

A client is a terminal provided to a household A, or a user of the terminal. It is possible to use a personal computer (PC) 4, a receiving unit 2 like a Set Top Box, and an after-mentioned mobile phone for the terminal. These clients are connected to an image forming apparatus 3 such as a printer, a copying machine, a facsimile machine and so on, through LAN (Local Area Network). In the following description, a system in LAN is called “the local system of the client”.

The receiving unit 2 is connected with TV 204 that is a display means. The receiving unit 2, the PC 4, the image forming apparatus 3 are connected to WAN (Wide Area Network) though an information processing apparatus (router) 6 provided with a connecting means for connecting each system or network of which protocol is different. The WAN is connected to the service provider D, a telecommunications carrier C like the Internet provider, and a broadcasting company B.

The broadcasting company B carries the digital broadcasting. The mode of the digital broadcasting may be either one of the BS (Broadcasting Satellite) digital broadcasting, the CS (Communication satellite) digital broadcasting, and the terrestrial digital broadcasting.

The digital broadcasting (the digital broadcasting type of print content) carried from the broadcasting company B can be received by a satellite or terrestrial antenna provided to the receiving unit 2. The digital broadcasting type of print content also can be received through WAN.

The telecommunications carrier C transmits the Web type of print content to WAN. The Web type of print content can be read by means of the Web browser installed in the PC 4.

Here is explained the operation of the printing fee reduction system in this embodiment.

The client issues a combine-and-print instruction. The combine-and-print instruction is issued from an operation means (not shown) of the PC 4 (FIG. 1, \mathring{1}-A) or from a remote controller (not shown) of the receiving unit 2 (FIG. 1, \mathring{1}-B).

The combine-and-print instruction is received by the image forming apparatus 3, and then the image forming apparatus 3 transfers said instruction to the service provider D (FIG. 1, \mathring{2}). Hereupon, the service provider D obtains the print content (which is called “main print data” hereinafter) in a way described below (FIG. 1, \mathring{3}).

The digital broadcasting type of main print data can be obtained from the receiving unit 2 (FIG. 1, \mathring{3}-B), or from the broadcasting company B (FIG. 1, \mathring{3}-C). And the Web type of main print data can be obtained from the PC 4 (FIG. 1, \mathring{3}-A), or from the telecommunications carrier C (FIG. 1, \mathring{3}-D). The main print data stored in the PC 4 (for example, a document prepared by the PC 4, and an e-mail received by the PC 4) can be obtained from the PC 4 (FIG. 1, \mathring{3}-A).

The service provider D combines the obtained main print data to an advertisement data, and transmits the combined print data to the image forming apparatus 3 through WAN (FIG. 1, \mathring{4}). The image forming apparatus 3 prints the combined print data, and notifies the service provider D of the number of printing sheets (that is, the number of sheets on which the advertisement data is printed) (FIG. 1, \mathring{5}).

At receiving the notice, the service provider D calculates points to reduce the printing fee based on the number of printing sheets, and manage the calculated points as client information (which is described later).

The fee reduction point is given to each client, and the calculation method is not limited in particular. In this embodiment, a value of the fee reduction points is found multiplying a print running cost per sheet of the image forming apparatus 3 by the number of printing sheets.

The print running cost includes not only a cost of a printing sheet but also the marking material to be used for printing a sheet. If it is possible to estimate how many sheets can be printed out with a marking material, the printing fee per sheet for the marking material can be calculated.

The print running cost may be in common to all the clients, or may be different according to each client. But when the print running cost is different per client, the apparatus information of the image forming apparatus 3 (the information of a kind of the marking material in use, for example) must be notified from the client to the service provider D in advance. Accordingly, if the marking material used by the image forming apparatus 3 is a different kind, the service provider D can calculate a proper print running cost.

According to the number of printing sheets informed by the image forming apparatus 3 in such way, the telecommunications carrier C calculates the advertisement publication points and manages the advertisement publication points as the advertiser information (which will be described later).

The calculated advertisement publication points are given to each advertiser, of which calculation method is not limited in particular. In this embodiment, the value of the advertisement publication points is the number of sheets on which the advertisement data is printed.

When the fee reduction points become a specific value, the service provider D sends the relevant client the marking material adaptive to the image forming apparatus 3. However, if the client uses a plurality of image forming apparatuses 3, or if the client plans to change the image forming apparatus 3, or if the user has a spare stock of the marking material, using such fee reduction points to redeem the marking material is not always the appropriate manner.

Therefore, when the fee reduction points become the specific value, it is preferable to inquiry the client whether the fee reduction points may be used to redeem the marking material or not. This method can eliminate the problem that the marking material is sent to the client against the client's wish.

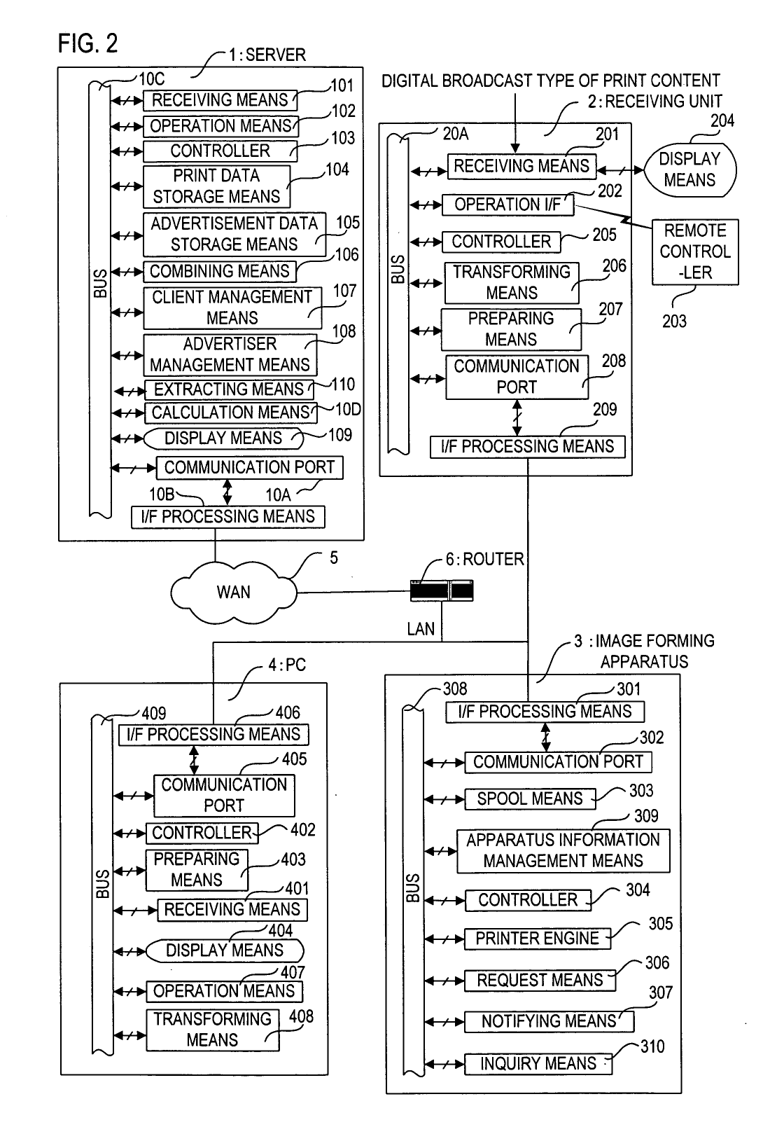

According to FIG. 2, the main components of the printing fee reduction system are explained.

The server 1 is provided within the service provider D. The receiving unit 2, the image forming apparatus 3, and the PC 4 are provided within the household A, and they are connected to the server 1 of the service provider D through the router 6 and WAN. Generally, the firewall for blocking the cracking from the external side is provide when the devices in the household A are connected to WAN in such way, but the illustration and explanation of the firewall are not described here.

The server 1 is a computer, to be concrete. It can be realized by connecting following respective means mutually through a bus 10C.

That is to say, a receiving means 101 displays the main print data received through WAN on a display means 109 such as a display, and stores the data in a print data storage means 104. A controller 103 receives an instruction from an operation means 102 such as a keyboard or from a control program, and then controls the operation of the server 1. A combining means 106 combines the print data stored in the print data storage means 105 and an advertisement data received from an extracting means 110 described later. A client management means 107 correlates the apparatus information of the image forming apparatus and the fee reduction points with a client identifier, and manages said information as the client information. An advertiser management means 108 correlates the information about the advertiser ordering this service and the advertisement publication points with an advertiser identifier, and manages said information as the advertiser information. The extracting means 110, in response to the instruction to combine the main print data and the advertisement data, extracts a proper advertisement data (which will be mentioned later) from the advertisement data stored in an advertisement data storage means 105, and then transfer the extracted data to the combining means 106. A calculation means 10D calculates the fee reduction points or the advertisement publication points according to the number of printing sheets notified by the image forming apparatus 3. A communication port 10A is connected to WAN 5 through I/F processing means 10B, and executes the connecting processing in response to the connection request sent from the client (I/F: Interface).

The receiving unit 2 is a Set Top Box, for example, and it is a receiver able to receive the content described in BML (Broadcast Markup Language) from the broadcast station and to browse it. Such receiving unit can be realized by connecting each following means mutually through bus 20A.

That is to say, a receiving means 201 displays the digital broadcasting type of main print data received from the broadcast station on a display means 204 such as TV. At receiving an instruction from a remote controller 203 through operation I/F 202, a controller 205 controls the operation of the receiving unit 1. A transforming unit transforms the digital broadcasting type of main print data from BML to an intermediate language like JAVA, the main print data received from the receiving means 201. A preparing means 207 prepares a print data based on the transformed data from the transforming means 206. A communication port 208 is connected to LAN through I/F processing means 209.

The PC 4 is a terminal that can receive the content described in HTML through the Internet and browse it, like a personal computer installing HTML (Hyper Text Markup Language) browser. Such terminal can be realized by connecting each following means mutually through bus 409.

That is to say, a receiving means 401 displays, on a display means 404 such as the display, the Web type of main print data received through WAN. A controller 402 receives the instruction from an operation means 407 such as the keyboard, and then controls the operation of the PC 4. A transforming means 408 transforms the Web type of main print data received from the receiving means 401 to an intermediate language like JAVA from HTML. A preparing means 403 prepares the print data based on the transformed data from the transforming means 408. A communication port 405 is connected to LAN through I/F processing means 406.

The printer and the digital integrated apparatus can be used as the image forming apparatus 3. The image forming apparatus 3 receives a print instruction from an external apparatus connected to the network like LAN, and then sends a server 1 a request to combine the main print data and the advertisement data. At receiving the combined print data, the image forming apparatus 3 prints the combined print data and notifies the server 1 of the number of sheets on which the advertisement data is printed. Such configured image forming apparatus can be realized by connecting the following respective devices with each other.

That is to say, a spool means 303 spools the combined print data sent from the external apparatus. A controller 304 rasterizes the spooled data by the spool means 303, and then sends said data to a printer engine 305 one after another. A request means 306 issues a combine-and-print instruction to the server 1 on demands. A notifying means 307 receives the combined print data from the server 1, and then notifies the server 1 of the number of sheets on which the advertisement data is printed. A device information management means 309 stores device information (for example, information about the marking material used by the device, information whether the device is provided with the both-side printing function or not, and information of the paper type used by the device), and notifies the server 1 of said device information on demand. An enquiry means 310 enquires of the user whether the main print data should be combined with the advertisement data or not, and as of specific particulars. A communication port 302 is connected with LAN through I/F processing means 301.

Here is a detailed explanation about the operation of the printing fee reduction system (regarding the main components, in particular).

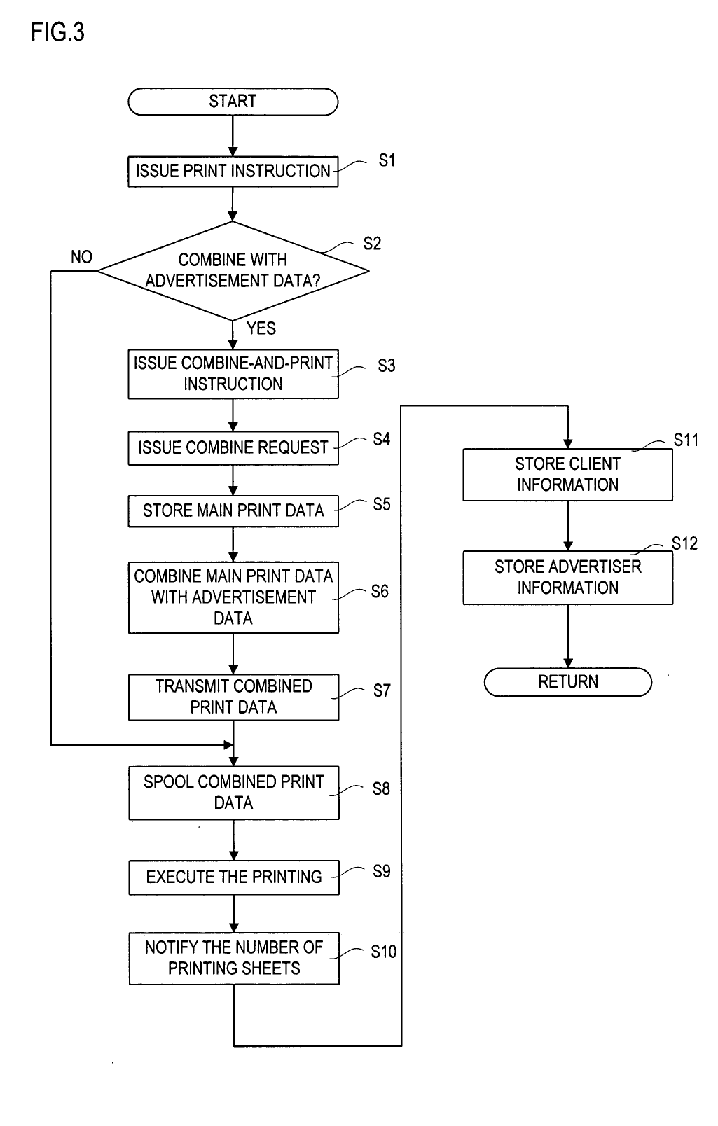

The user of the PC 4 sends the instruction to print the main print data stored in the PC 4 toward the image forming apparatus 3 (FIG. 3, Step 1). In response to the instruction, the enquiry means 310 of the image forming apparatus 3 enquires of the user of the PC 4 whether the printing is executed after the main print data is combined with the advertisement data (FIG. 3, Step 2).

When the user wants to combine the main print data with the advertisement data, the PC 4 sends the image forming apparatus 3 the instruction to combine the main print data and the advertisement data (combine-and-print instruction) as well as sends the main print data to the server 1 (FIG. 3, Step S2 to Step S3). On the other hand, when the user does not want to combine the main print data with the advertisement data, the PC 4 sends the main print data to the image forming apparatus (FIG. 3, Step S2 to Step S8).

The request means 306 of the image forming apparatus 3 receives the combine-and-print instruction through the I/F processing means 301, the communication port 302, and the bus 308, and then sends the server 1 a request to combine the main print data and the advertisement data (combine request) (FIG. 3, Step S4). The server 1 receives the combine request from the image forming apparatus 3, meanwhile receives the main print data from the PC 4 and stores the data in the print data storage means 104 (FIG. 3, Step S5).

The extracting means 110 of the server 1 extracts a proper one from the advertisement data stored in the advertisement data storage means 105, and transfers said data to the combining means 106. The combining means 106 combines the main print data stored in the print data storage means 104 and the advertisement data received from the extracting means 110 (FIG. 3, Step S6), and then transfers the combined print data to the request means 306 of the image forming apparatus 3.

Besides, the device information of the image forming apparatus 3 is correlated with the client identifier, which can be registered in the client management means 107 of the server 1, as the client information. The device information stored in the device information management means 309 of the image forming apparatus 3 should have been notified to the server 1 in advance. The device information was registered in the client information management means 107 of the server 1.

Moreover, the information about the advertiser ordering the service is correlated with the advertiser identifier, which can be registered in the advertiser management means 108 of the server 1 as the advertiser information. In this case, the information about the advertiser should have been notified to the server 1 from the advertiser in any way, in advance.

Before starting the service, it is preferable to recruit the advertiser in advance. It is sure that the information about the advertiser can be deleted or added at any time. Even after starting the service, it is possible to continue to recruit the advertiser.

After combining the main print data and the advertisement data (FIG. 3, Step S6), the server 1 sends the combined print data together with the advertiser identifier to the image forming apparatus 3 through WAN, the router 6, and LAN (FIG. 3, Step S7). The combined print data thus sent is spooled into the spool means 303 of the image forming apparatus 3 (FIG. 3, Step S8).

The controller 304 of the image forming apparatus 3 rasterizes the spooled combined print data sequentially, and sends them to the printer engine 305, and executes the printing (FIG. 3, Step S9). The notifying means 307 of the image forming apparatus 3 counts the number of sheets on which the advertisement data is printed for every advertiser, and the result (the number of printing sheets of the advertisement data and the advertiser identifier) is notified to the server 1 through WAN, the router 6, and LAN (FIG. 3, Step S10).

The calculation means 10D of the server 1, if receiving the apparatus information from the client, calculates the fee reduction points based on the apparatus information (FIG. 3, Step S11).

On the other hand, the calculation means 10D of the server 1, if not receiving the apparatus information from the client, calculates the fee reduction points based on a default conversion value. And the fee reduction points are stored in the client management means 107 as the client information (FIG. 3, Step S11).

Additionally, the calculation means 10D of the server 1 calculates the advertisement publication points and stores the value in the advertiser management means 108 as the advertiser information (FIG. 3, Step S12). To make it possible to give the advertisement publication points to a specific advertiser in such way, it is designed that the image forming apparatus 3 informs the advertiser identifier to the server 1 (FIG. 3, Step S10).

As described above, when the fee reduction points managed by the client management means 107 become a specific value, the fee reduction points can be used to redeem the marking material. The specific value may correspond to the number of printing sheets that a new marking material can print until the residual of the marking material becomes approximately 0. According to such configuration, if the client always selects the option of incorporating the advertisement data, the client can obtain a new marking material when the residual of the marking material becomes almost 0.

The method of exchanging the fee reduction points and the marking material is not limited in particular. For instance, when the fee reduction points become a specific value, it may automatically send a new marking material to the client.

Otherwise, when the fee reduction points become a specific value, it may inquire of the client whether the fee reduction points are used to redeem the marking material. In such case, it is sure that, only when it receives from the client the response that the fee reduction point may be used to redeem the marking material, a new marking material may be sent to the client.

As described above, the invention adopts the method of reducing the fee for printing by incorporating the advertisement into the printed matter. In result, it is nevertheless to say that the advertisement provided through the Internet is printed actively.

Moreover, the invention can combine the main print data stored in the client (the document prepared by the PC 4, or the E-mail received by the PC4) with the advertisement data. This can increase the user's willingness of the printing, and the advertisement provided through the Internet is printed actively furthermore.

The printing fee is sure to be charged to the advertiser providing the advertisement data combined with the main print data. Even though the advertiser must pay the printing fee, the advertiser can expect the high publicity because the advertisement is printed being combined with the main print data.

Though it is designed in the above description that the main print data is transferred to the server 1 through the client (FIG. 3, Step S3), the invention is not limited to this. That is to say, the main data may be transferred direct to the server 1 from the broadcasting company B or the telecommunications carrier C according to the instruction of the client.

And, it is configured in the above description that the extracting means 110 of the server 1 extracts a proper advertisement data from the advertisement data stored in the advertisement data storage means 105, and the extracting method is explained here in detail.

The advertisement data storage means 105 stores various field of advertisement data. Therefore, in order to extract a proper advertisement data from them, the extracting means 110 of the server 1 may recognize each user's favorite field.

There are many methods of carrying out this and the method is not limited in particular. But one simple method is to obtain the information of the user's favorite by the questionnaire method in advance, and manage the result as the client information by the client management means 107. Otherwise, it may adopt the following configuration; when it is requested to extract the advertisement data from the advertisement data storage means 105 of the server 1, the inquiry means 111 of the server 1 (which will be described later) inquires of the client as to his favorite advertisement, and the response is notified to the extracting means 110. Even when either method is adopted, it is possible to extract the advertisement data to the user's favorite from the various fields of advertisement data stored in the advertisement data storage means 105 of the server 1.

There is a high possibility that a newly arrived advertisement data and an advertisement data with a high discount rate are beneficial to all users. Accordingly, it is effective that the extracting means 110 is configured to extract such advertisement data first rather than the other advertisement data.

### Embodiment 2

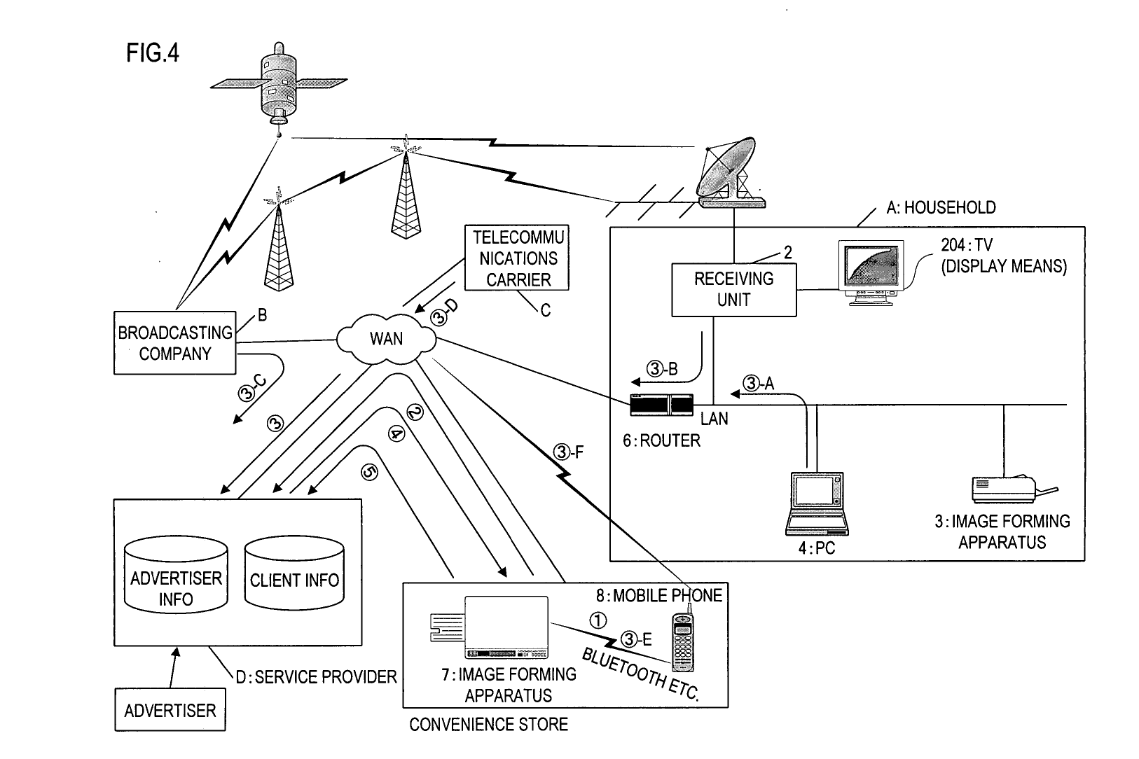

Here is explained the preferred embodiment regarding the difference from the above embodiment 1, according to FIG. 4.

In a convenience store, an image forming apparatus 7 is equipped in order to provide the services. The image forming apparatus 7 is provided with a wireless I/F to communicate with an external apparatus (e.g., a mobile phone 8, in this embodiment) through wireless network such as Bluetooth and wireless LAN, in addition to the configuration of the image forming apparatus 3 described in the first embodiment. The image forming apparatus 7 is also provided with LAN I/F, and is connected with WAN through the LAN I/F.

In the first embodiment, the system in the household A is defined as the local system of the client. But, it is decided in this embodiment that a system in the convenience store (that is, a system comprising the image forming apparatus 7 and the mobile phone 8) is the local system of the client.

A mobile phone in which the i-mode is available can be adopted as the mobile phone 8. The mobile phone is provided with a wireless I/F to communicate with an external apparatus (the image forming apparatus 7, in this embodiment) through wireless network such as Bluetooth or wireless LAN.

The user sends the image forming apparatus the combine-and-print instruction by means of the mobile phone 8 at the convenience store (FIG. 4, \mathring{1}). After the combine-and-print instruction is received by the image forming apparatus 7, the image forming apparatus 7 transfers said instruction to the service provider D (FIG. 4, \mathring{2}). And hereupon, the service provider D obtains the main print data as follows (FIG. 4, \mathring{3}).

The digital broadcasting type of main print data is obtained from the receiving unit 2 (FIG. 4, \mathring{3}-C), or the broadcasting company B (FIG. 4, \mathring{3}-C). And the Web type of main print data is obtained from the PC4 (FIG. 4, \mathring{3}-A) or the telecommunication carrier C (FIG. 4, \mathring{3}-D). The main print data stored in the PC4 is obtained from the PC 4 (FIG. 4, \mathring{3}-A). And the main print data stored in the mobile phone is obtained from the mobile phone 8 through the image forming apparatus 7 (FIG. 4, \mathring{3}-E) or directly from the communication network of the mobile phone (FIG. 4, \mathring{3}-F).

The service provider D combines the obtained main print data and the advertisement data, which is sent to the image forming apparatus 7 through WAN (FIG. 4, \mathring{4}). Thereby, the image forming apparatus 7 prints the combined print data, and then notifies the service provider D of the number of the printing sheets (the number of sheets on which the advertisement data are printed) (FIG. 4, \mathring{5}).

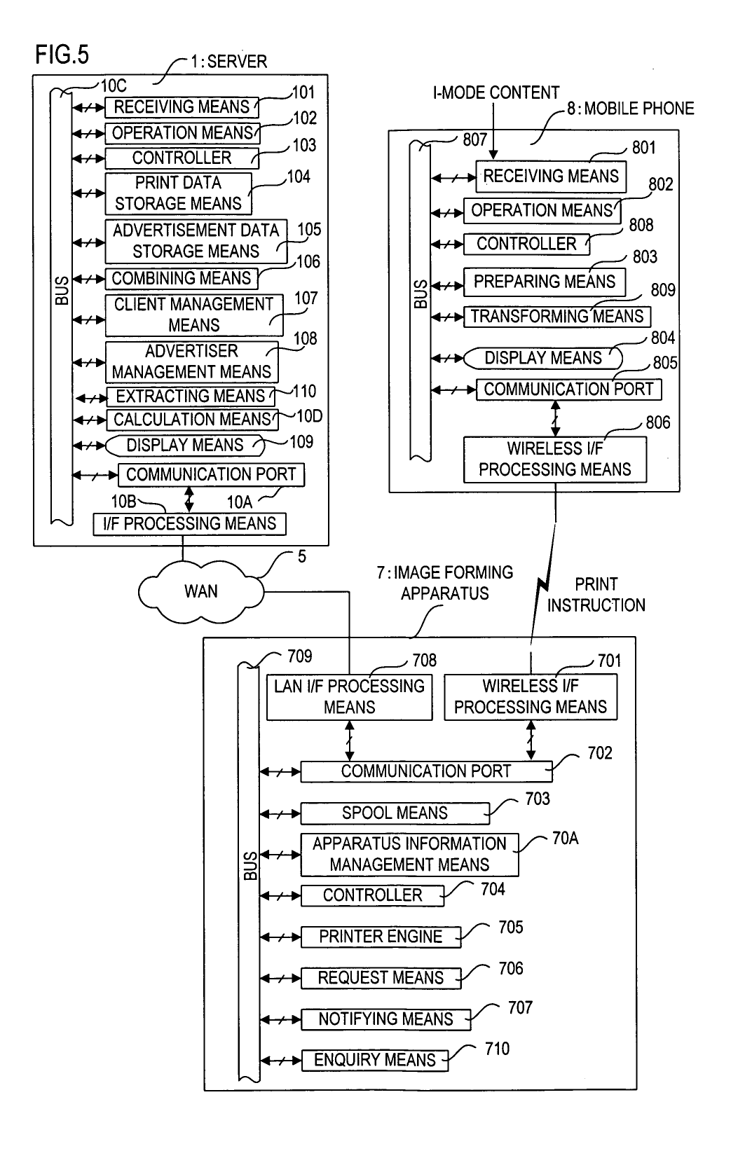

Next, according to FIG. 5, the main components of the printing fee reduction system in this embodiment is explained here. The server 1 in the service provider D and the devices in the household A are the same as those in the first embodiment, of which explanation is omitted here.

The mobile phone 8 can receive the content described in CHTML (Compact Hyper Text markup Language) through the Internet and browse said content, like the mobile phone in which the i-mode is available. The mobile phone is used connecting respective means described hereinafter by means of the bus 807.

A receiving means 801 displays the i-mode type of content received through the Internet on a display means 804. A controller 808 controls the operation of the mobile phone 8 according to the instruction from an operation means 802. A transforming means 809 transforms the i-mode type of content from CHTML to the intermediate language like JAVA, the i-mode type of content received from the receiving means 801. A preparing mans 803 prepares the print data based on the transformed data from the transforming means 809. A communication port 805 is connected with a wireless network through I/F processing means 806.

It is only the I/F processing means of an image forming apparatus 7 in this embodiment that is different from the image forming apparatus 3 in the first embodiment. That is to say, the I/F processing means of the image forming apparatus 7 in this embodiment comprises a wireless I/F processing means 701 and a LAN I/F processing means 707. The wireless I/F processing means 701 is provided with a function to connect with an external device through the wireless network like the Bluetooth or the wireless LAN. The LAN I/F processing means 707 is provided with a function to connect with WAN 5 through LAN.

The following explanation is the details about the operation of the printing fee reduction system (main components, in particular).

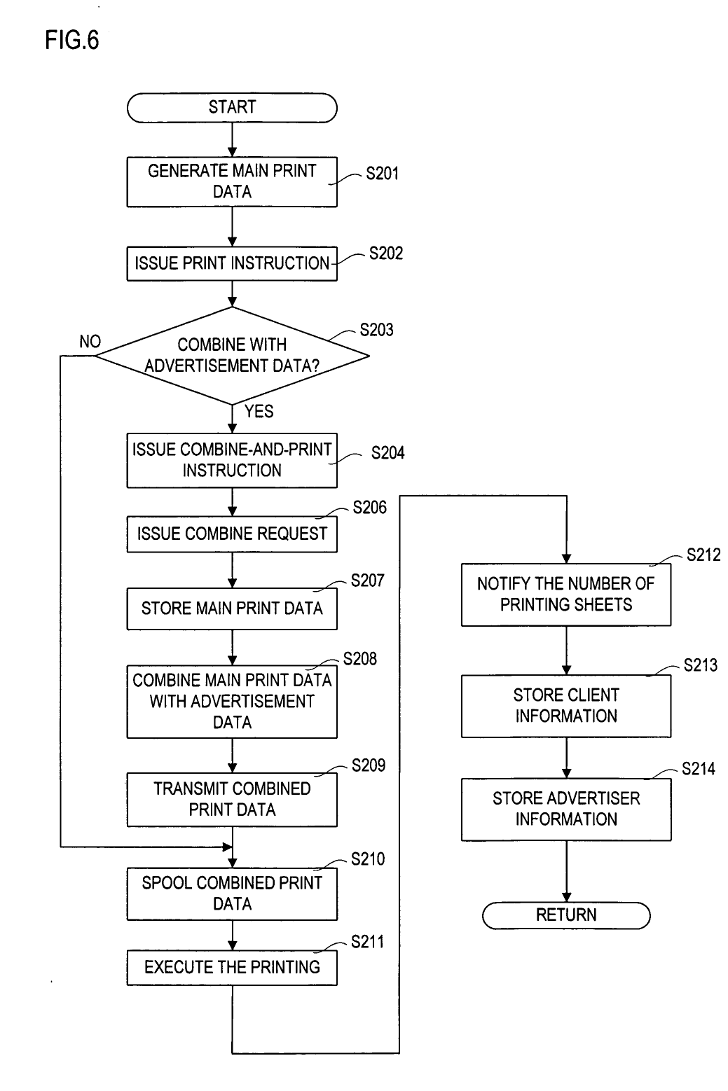

The user received the i-mode type of content by the receiving means 801 of the mobile phone 8. The i-mode type of content is transformed to the intermediate language like JAVA by the transforming means 809. And based on the transformed i-mode type of content, the preparing means 803 prepares the main print data (FIG. 6, Step S201).

The user changes the function of the operation means 802 from the communication mode to the printing mode, and then sends the image forming apparatus 7 the instruction to print the prepared main print data (FIG. 6, Step S202). In response to the instruction, an inquiry means 710 of the image forming apparatus 7 inquires of the user of the mobile phone whether the main print data is printed being combined with the advertisement data (FIG. 6, Step S203).

If the user wants to combine the main print data with the advertisement data, the mobile phone 8 sends the server 1 the main print data and at the same time sends the image forming apparatus 3 an instruction to combine the main print data and the advertisement data (the combine-and-print instruction) (FIG. 6, Step S203 to Step S204). On the other hand, if the user does not want to combine the main print data with the advertisement data, the mobile phone 8 sends the main print data to the image forming apparatus 3 (FIG. 6, Step S203 to Step S210).

A request means 706 of the image forming apparatus 7 receives the combine-and-print instruction through the wireless I/F processing means 701, the communication port 702 and the bus 708, and then sends the server 1 the request to combine the main print data and the advertisement data (combine request) (FIG. 6, Step S206). While receiving the combine request from the image forming apparatus 7, the server 1 receives the main print data from the mobile phone 8 and stores them in the print data storage means 104 (FIG. 6, Step S207).

The operation following to the above (FIG. 6, Steps S208 to S214) is the same as in the first embodiment (FIG. 3, Steps S6 to S12). Accordingly, the explanation about such operation is not described here.

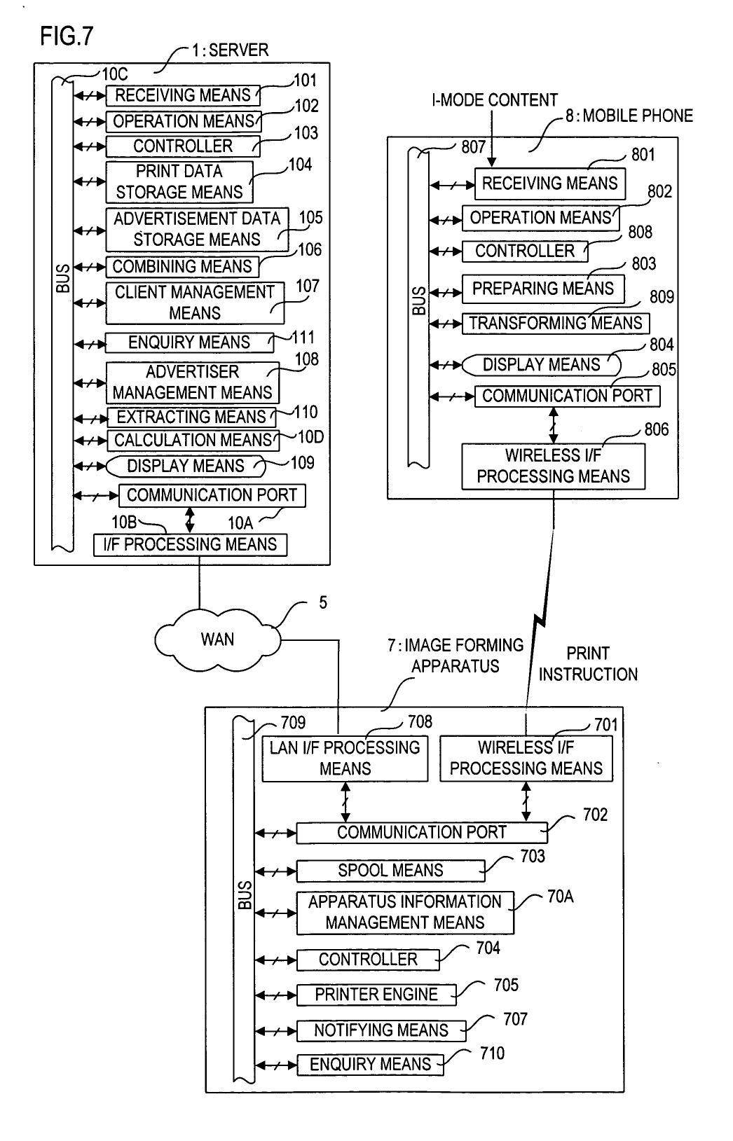

In this embodiment, there is another configuration in which the image forming apparatus is not provided with the communication I/F for the mobile phone 8. In case of adopting such configuration, an inquiry means 111 as described hereafter is provided to the server 1 instead of the request means 706, as shown in FIG. 7.

That is to say, when the mobile phone 8 sends the print instruction to the server 1 or transfers the main print data (the content to be printed) to the server 1 through the communication network of the mobile phone 8, the inquiry means 111 of the server 1 inquires of the user of the mobile phone 8 whether the main print data should be combined with the advertisement data or not. In response to the inquiry, when the user of the mobile phone 8 sends the instruction to combine the main print data and the advertisement data, the extracting means 110 is activated in the same way as above and extracts a proper advertisement data.

The advertisement data thus extracted is combined with the main print data by the combining means 110, which is transferred to the image forming apparatus 7 and printed out there. It is sure that, when the user of the mobile phone 8 sends the instruction not to combine the main print data and the advertisement data, only the main print data is transferred to the image forming apparatus and printed out.

Even if the communication I/F for the mobile phone 8 is provided to the image forming apparatus 7, the inquiry means 111 may be provided to the server 1, instead of the request means 706. In such case, the print instruction or the content that the user wants to print out may be transferred from the client to the server 1 through the image forming apparatus 7.

As described above, the invention of this embodiment can combine the i-mode type of content received by the mobile phone and the advertisement data, and print said data by means of the image forming apparatus equipped at the convenience store. There is a merit even in this embodiment that the advertisement provided through the Internet is printed out actively. And it is possible for the advertiser to expect to increase the effect of the advertisement.

It is sure that the place on which the image forming apparatus is established is not limited to the convenience store. That is to say, in case of placing the image forming apparatus in the office, it is possible to obtain the same effect.

The above exemplifies the operation that the service provider D obtains the main print data when the combine-and-print instruction is transferred to the service provider D. However, the invention is not limited to this. That is to say, if the user sets his mobile phone to receive the main print data, the user can receive the main print data by his mobile phone at any place away from home and print said data at the convenience store.

The above-mentioned method of receiving the main print data by the mobile phone is not limited in particular, but it is preferable to receive the E-mail attached with the main print data. The technology that the mobile phone receives the E-mail attached with the image data or audio data has been well known at present. By applying the technology to the system of the invention, it is possible to simplify the operation of setting the user's mobile phone to receive the main print data and the operation of receiving the main print data outside his home and printing the received data at the convenience store. The merit is large.

In addition, the above describes that the main print data is transferred to the server 1 through the client (FIG. 6, Step S204), but the invention is not limited to this. That is to say, the main print data may be transferred direct from the broadcasting company B or the telecommunications carrier C to the server 1 according to the client's instruction.

Moreover, the above describes that the main print data is transferred to the server 1 through the image forming apparatus 7 (FIG. 6, Step S207), but the invention is not limited to this. That is to say, the main print data may be transferred direct from the network of the mobile phone 8 to the server 1 through WAN.

### Embodiment 3

The invention is configured in the first embodiment that the main print data is combined with the advertisement data in the server 1. On the contrary, the invention is configured in this embodiment that the main print data is combined with the advertisement data in the image forming apparatus 3.

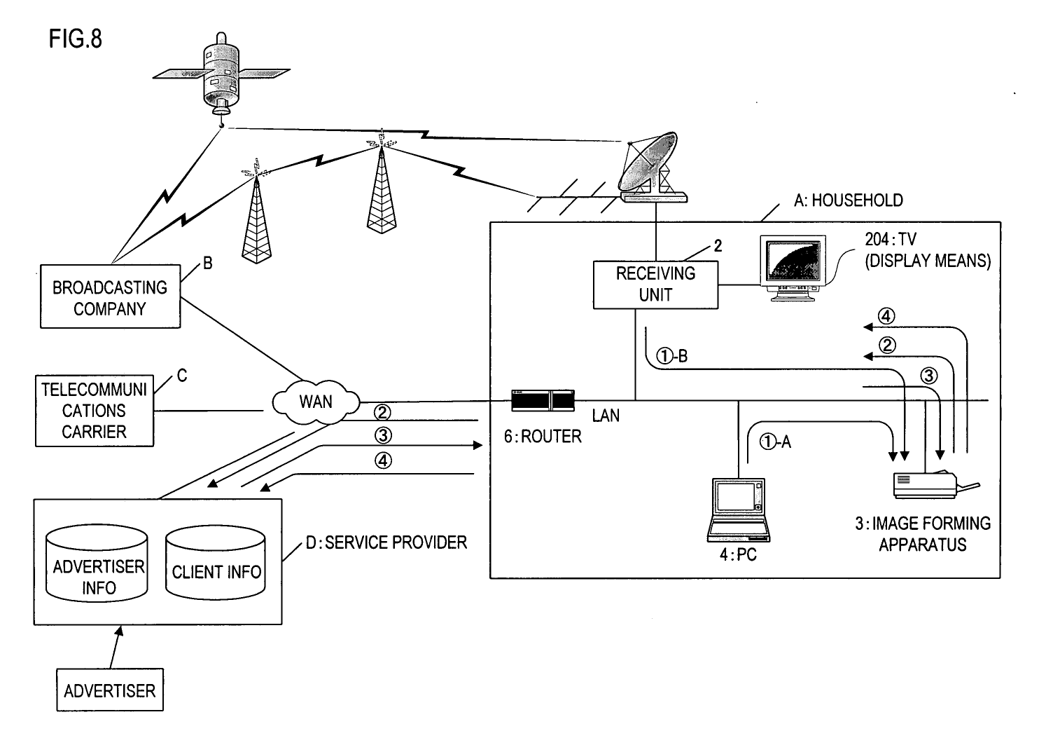

According to FIG. 8, this preferred embodiment is explained hereinafter regarding the points that are different from those of the first embodiment.

When receiving the main print data and the combine-and-print instruction from a client such as PC 4 or a receiver unit 2 (FIG. 8, \mathring{1}-A, \mathring{1}-B), the image forming apparatus 3 requests the service provider D to send the advertisement data (FIG. 8, \mathring{2}). The image forming apparatus is configured to provide the general printing without requesting the service provider D to send the advertisement data in response to the general print instruction instead of the combine-and-print instruction.

The server 1 extracts an appropriate advertisement data in response to the request to send advertisement data from the image forming apparatus 3, and transmits said data to the image forming apparatus 3 (FIG. 8, \mathring{3}). Then, the image forming apparatus 3 combines the received advertisement data with the main print data that has been received from the client, and prints said combined print data. And the number of printing sheets of the advertisement data is informed to the service provider D (FIG. 8, \mathring{4}).

The following description relates to the main components of the printing fee reduction system of the invention.

The system in the first embodiment adopts a configuration that the sever 1 is provided with the combining means 106 for combining the main print data and the advertisement data. On the other hand, the system in this embodiment adopts a configuration that the image forming apparatus 3 is provided with the combining means 307 for combining the main print data and the advertisement data.

The operation of the printing fee reduction system (the main components, in particular) is explained hereinafter in details.

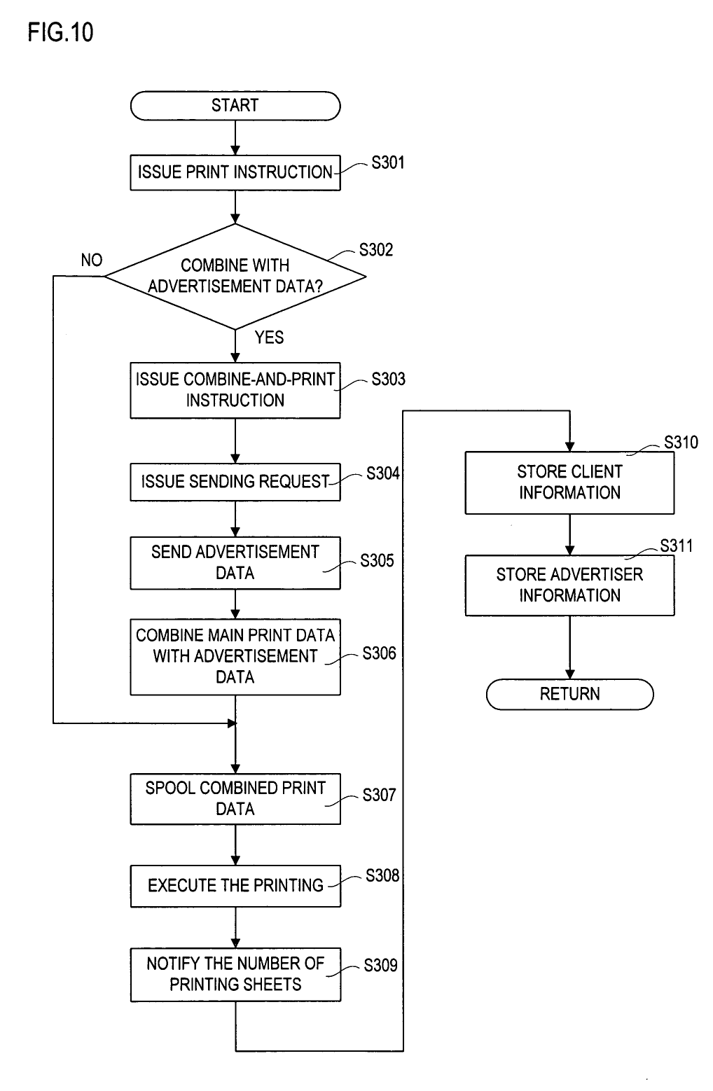

Like the first embodiment, a user of the PC 4 sends the image forming apparatus 3 an instruction to print the main print data stored in the PC4 (FIG. 10, Step S301). In response to the instruction, the request means 306 of the image forming apparatus 3 inquires of the user of the PC 4 whether the main print data is printed being combined with the advertisement data (FIG. 10, Step S302).

When the user wants to combine the main print data with the advertisement data, the PC 4 sends the image forming apparatus 3 the main print data together with an instruction (combine-and-print instruction) to combine the main print data with the advertisement data (FIG. 10, Step S302 to S303). Or, when the user does not want to combine the main print data with the advertisement data, the PC 4 sends the main print data to the image forming apparatus 3 (FIG. 10, Step S302 to S307).

At receiving the combine-and-print instruction through the I/F processing means 301, the communication port 302 and the bus 308, the request means 306 of the image forming apparatus 3 sends the server 1 a request (sending request) to send the advertisement data to be combined with the main print data (FIG. 10, Step S304). After receiving the sending request from the image forming apparatus 3, the extracting means 110 of the server 1 extracts an appropriate one among the advertisement data stored in the advertisement data storage means 105, and then sends the extracted advertisement data to the image forming apparatus 3 (FIG. 10, Step S305). The combining means 307 of the image forming apparatus 3 combines the extracted advertisement data with the main print data that has been received from the PC 4, by which the combined print data is prepared (FIG. 10, Step S306).

The operations following to the above (FIG. 10, Steps S307 to S311) are the same as those described in the first embodiment (FIG. 3, Steps S8 to S12), accordingly, those operations will not be explained here.

As described above, it is configured in this embodiment that the main print data is combined with the advertisement data in the image forming apparatus 3. Therefore, the system can provide the merit that the advertisement provided through the Internet is printed actively, and also a merit that the advertiser can expect the high publicity effect.

In addition, the system in this embodiment does not allow the main print data stored in the client to leak outside from the household A, with the result with that the security can be assured. Even if the system is configured that the main print data stored in the client is combined with the advertisement data like the first embodiment, it is possible to control the security trouble by encrypting the main print data for the transmission. Hereupon, if it is necessary to assure the security certainly, the system may adopt the method of combining the main print data with the advertisement data in the image forming apparatus 3, like this embodiment.

It is configured in the above that the main print data is combined with the advertisement data in the image forming apparatus. But the present invention is not limited to this. That is to say, the main print data may be combined with the advertisement data in devices equipped in the household A (the receiving unit 2, the router 6, and a not-shown facsimile machine). According to such configuration, the main print data will not leak outside from the household A, as the result with that the security of the main print data can be also assured likewise.

In case of combining the main print data with the advertisement data in the receiving unit 2 provided within the household A, the advertisement data can be printed out being combined with an electronic mail received by the receiving unit 2. And when the main print data and the advertisement data are combined in the facsimile machine provided within the household A, the advertisement data can be printed out being combined to the image data received by the facsimile machine.

The above explanation exemplifies the operation that the image forming apparatus 3 receives the advertisement data from the server 1 when the PC 4 sends the image forming apparatus 3 the combine instruction; however, the method of obtaining the advertisement data is not limited to this. That is to say, in order to combine the main print data with the advertisement data in the facsimile machine provided in the household A, the facsimile machine may obtain the advertisement data by connecting to the server 1 by toll free call and so on. Otherwise, if the facsimile machine is provided with a function to connect to the Internet, the facsimile machine is sure to obtain the advertisement data from the server 1 through the Internet. Not only the facsimile machine but also the digital integrated apparatus can adopt this method of obtaining the advertisement data.

Besides, in case of combining the main print data and the advertisement data in an information processing apparatus provided in the household A like this embodiment, the information processing apparatus may be configured to be provided with a storage means for storing advertisement data, which will be described later.

### Embodiment 4

As described in the above embodiments, the combining means 106 and 307 combine the advertisement data to the main print data. This embodiment relates to the combining process of the advertisement data to the main print data, in details.

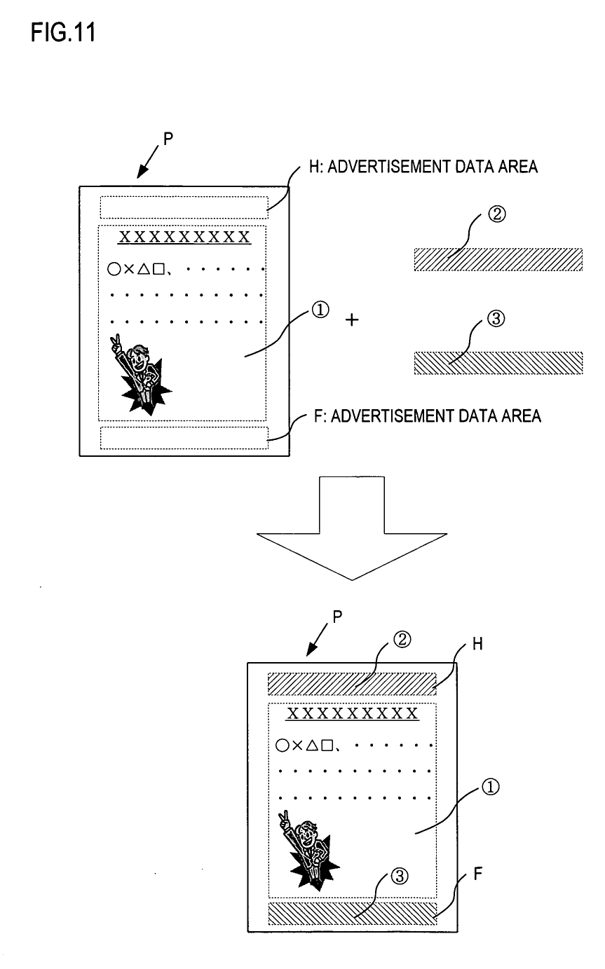

As shown in FIG. 11, a header H or a footer F of a page P may be used for an advertisement data area. In such case, the main print data \mathring{1} is printed in the center of the page P, the advertisement data \mathring{2} is printed in the header H of the page P, and the advertisement data \mathring{3} is printed in the footer F of the page P.

The above exemplifies that two advertisement data \mathring{2} and \mathring{3} are combined to one main print data \mathring{1}, but the number of advertisement data to be combined to the one main print data is not limited to this. That is to say, the number of the advertisement data to be combined to the one main print data may be one or three and more.

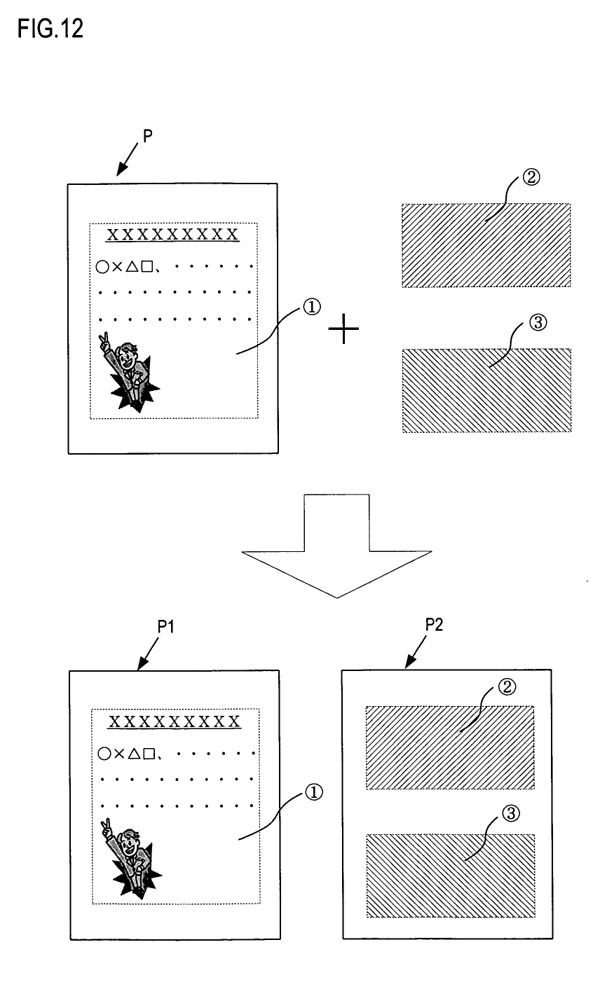

The image forming apparatus 3(7) is often provided with a both-side print function. In such case, it may configure as shown in FIG. 12 that the main print data \mathring{1} be printed on a front page P1 and the advertisement data \mathring{2} and \mathring{3} may be printed on a back page P2. As shown by the example of printing the advertisement data on the back page, there is a merit that the larger area for the advertisement can be assured by comparison with the example of printing the advertisement data on the header or the footer of the page.

The above exemplifies that two advertisement data \mathring{2} and \mathring{3} are combined to one main print data \mathring{1}. The number of advertisement data combined to one main print data is not limited to this. That is to say, the number of advertisement data to be combined to one main print data may be 1 or 3 and more.

In case of combining the main print data and the advertisement data in the server 1 instead of the image forming apparatus 3, the image forming apparatus 3 may send the server 1 the information whether the image forming apparatus 3 is provided with the both-side print function. If the image forming apparatus is provided with the both-side print function, the server 1 can combine the respective data so that the main print data is printed on an odd page while the advertisement data on an even page, and send said data to the image forming apparatus 3.

As also described briefly in the above, the fee reduction points given to a client and the advertisement publication points given to the advertiser may increase according to the number of advertisement data printed by the image forming apparatus 3. That is to say, when a plurality of advertisement data are printed on one page, the fee reduction points and the advertisement publication points should be calculated according to the number of advertisement data. Hereupon, even when a plurality of advertisement data are printed on one page, it is possible to give the fee reduction points to the client as well as the advertisement publication points to the advertiser.

In addition, the fee reduction points to the client and the advertisement publication points to the advertiser may be changed according to a space of the advertisement. In this case, the larger the space of advertisement is, the more points can be given.

Without printing the main print data, only the advertisement data may be printed. In this case, the fee reduction points to the client should be more than the fee reduction points given at the combination of the main print data and the advertisement data.

In addition, the main print data is printed on plural pages, the advertisement data may be printed on a specific one of those pages (the last page, for example). The number of specific pages and the number of the advertisement data included in the specific pages are not limited in particular.

Moreover, the main print data may be regarded as different data from the advertisement data, and each data may be printed consecutively. At this time, the main print data is not always combined to the advertisement data. However, there is a necessity that the main print data and the advertisement data are handled as a set of data. This means that the main print data is combined to the advertisement data, practically.

### Embodiment 5

One of services provided by a convenience store is to copy originals. That is to say, the user pays the printing fee (e.g. ¥10 per page) and then copies the originals by using the copying machine provided to the convenience store.

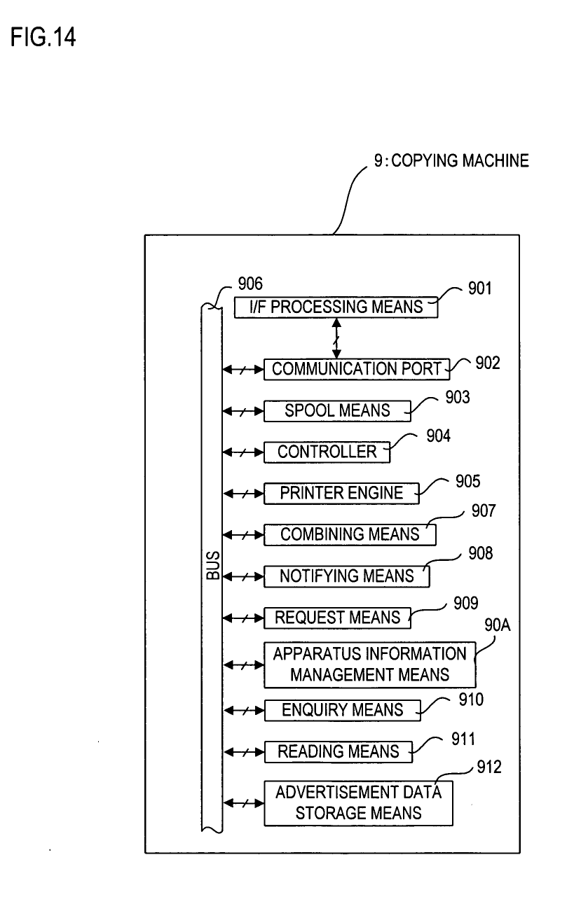

The present invention may be applied to the above-mentioned copying machine. The copying machine is added with an image reading means 911 for reading an original optically and preparing the image data of the original as shown in FIG. 14. And other than this means, the configuration is basically the same as the image forming apparatus 3 or 7.

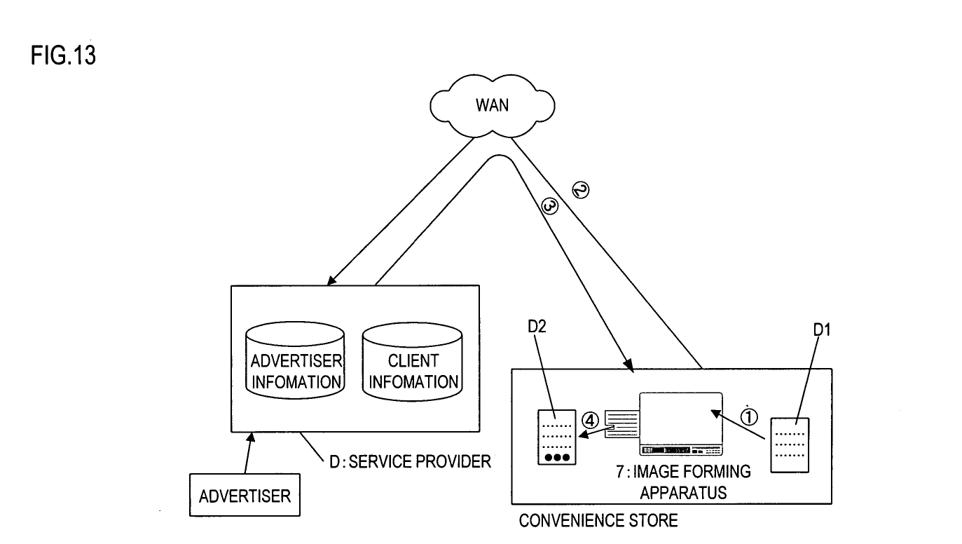

When a user issues an instruction to copy an original Dl (FIG. 13, Step \mathring{1}), an inquiry means 910 of a copying machine 9, which receives the instruction, displays a message that the fee is reduced by incorporating the advertisement into the original and asks the user whether the advertisement is combined to the original. The inquiry means 910 can be carried out by a liquid crystal display for the setting provided to the copying machine 9.

Accordingly, in case of receiving a response that the advertisement is combined to the original, the reading means 910 of the copying machine 9 reads the original D1 optically and then prepare the image data of the original. The original image data thus prepared is combined with the advertisement data by the combining means 907, which is transcribed on papers and outputted as a copy original D2 (FIG. 13, Step \mathring{2} to Step \mathring{3} to Step \mathring{4}).

On the other hand, in case of receiving the response that the advertisement is not combined to the original, the copying machine executes the general copying procedure. Specifically, the original image data, thus prepared by the reading means 910 of the copying machine 9, is not combined with the advertisement, and then transcribed on papers and outputted as the copy original D2 (FIG. 13, Step \mathring{4}).

As described in the fourth embodiment, if the advertisement data is incorporated into every page respectively, the combining means 907 may be activated when each original image data is prepared. The activated combining means 907 is configured to combine the advertisement data to the original image data, whenever the original image data of each page is prepared.

Otherwise, when the original image data for all pages are prepared (a method for detecting said time will be described later), the combining means 907 may be activated. It is sure that the activated combining means 907 combines the advertisement data with the original image data of all pages.

The position that the advertisement data is combined to the original image data is basically the same as the fourth embodiment. Accordingly, this method is not described here in detail.

On the other hand, in case of combining the advertisement to a specific page, the combining means 907 must be activated when the original image data of this page is prepared. For this processing, the reading means 910 may count the number of the reading procedure every time the reading of the original.

And hereupon, the reading means 910 detects that the preparation of the original image data of the specific page is completed, and then send the combining means an instruction to combines the advertisement data to the original image data. It is sure that the information about the page to be incorporated with the advertisement data has been notified to the combining means from the inquiry means 910.

In case of copying a plurality of originals, it is general that those originals are placed on the ADF (Auto Document Feeder). When all the originals on the ADF have been fed to the reading means, it is obvious that the reading means has read all the originals. Therefore, it is possible to incorporate the advertisement data to only the last page of the original image data.

Like the first to fourth embodiments, the advertisement data may be obtained from the server 1 (the configuration of the server 1 was explained and here is not explained about it here). But in the copying machine 9 of this embedment, of which application is a special case, there is a possibility that the main print data is frequently combined with the advertisement data. Therefore, instead of adopting the configuration that the advertisement data is obtained from the server 1 when there is the necessity for the data, the system adopts a mechanism that some of the advertisement data has been obtained from the server 1 at fixed intervals (FIG. 13, Step \mathring{2} to Step \mathring{3}).

A request means 909 of the copying machine 9 sends the server 1 a request to send the advertisement data to be combined with the main print data (sending request) at predetermined time. In response to this request, the extracting means 110 of the server 1 extracts a proper advertisement data (e.g., latest advertisement data) from the advertisement data stored in the advertisement data storage means 105 and sends said data to the copying machine 9.

The advertisement data is stored in the advertisement data storage means 912 of the copying machine 912. And thus stored data is read by the combining means 907 on demand, and then combined the original image data prepared by the reading means 911.

There are various methods of reading the advertisement data from the advertisement data storage means 912 by the combining means, and the reading method is not limited in particular. That is to say, in case of incorporating the advertisement data into all pages respectively, at either time of when the preparation of the original image data for each page is completed or when the preparation of the original image data for all pages is completed, the combining means 907 may read the advertisement data from the advertisement data storage means 912. And the number of the advertisement data to be read from the advertisement data storage means 912 may be one or a plurality.

As described above, according to the configuration that the advertisement data has been obtained from the server at fixed intervals, the invention has a merit that it is not necessary to execute the communication between the server 1 and the convenience store so many times and it is possible to shorten the time for response to the user. This mechanism of obtaining the advertisement data may be applied to the image forming apparatus in the third embodiment.

It is also configured in the third embodiment that the main print data is combined with the advertisement data in the image forming apparatus 3. The image forming apparatus 3 is further provided with the advertisement data storage means (not shown in the drawing). The advertisement data obtained from the server 1 may be stored in the advertisement data storage means. According to such configuration, it is possible to obtain the same effect like the above.

The information about the copying machine maker and the goods on sale in the convenience store may be used for the advertisement data, which is very effective. And this can increase the gross sales of the copying machine and the goods in the convenience store.

The coupon ticket may be contained in the advertisement data. The store carries out the service that a predetermined good may be discounted by showing the printed coupon ticket, which can increase the user's willingness to buy. And the service of allowing a discount for the predetermined good may be executed by showing a coupon on the display of the mobile phone to the store clerk.

After copying the original Dl, the user pays the printing fee to the cashier of the convenience store. It is sure that the printing fee in case of combining the copy original D2 with the advertisement is reduced more than the printing fee in case of not combining with the advertisement. The degree of the discount may be determined according to the number of the printed advertisement data like the first to fourth embodiments.

However, in case of a plural number of printing sheets, a same advertisement data is printed on plural printing sheets. At this time, it is not preferable that the printing fee is simply determined according to the number of the advertisement data. When the same advertisement data is printed on plural printing sheets, the printing fee may be determined as considered that one advertisement data is printed.

As described above, the invention can be applied to the copying machine provided to the convenience store. In this case, however, by adopting the method of using the fee reduction points to redeem the marking material like the first to fourth embodiments, it is not possible to discount the printing fee. Therefore, the invention of this embodiment adopts the discount mechanism of the printing fee.

The method of reducing the printing fee in this embodiment is different from the other embodiments, but the other mechanism (the reduction of the printing fee; and the combine of the main print data stored in the advertisement data) is the same as the other embodiments. That is to say, “the original image data” in this embodiment may be handled like “the content stored in the client” described in the first to fourth embodiments. “The image data received by the facsimile machine” in the fourth embodiment can be also handled like “the content stored in the client”.

This embodiment exemplifies the copying machine provided to the convenience store, but the place to be provided with this copying machine is not limited to the convenience store. For instance, when the copying machine is provided to the office, if it is a rent machine, it is possible to adopt the way of discounting the printing fee like the above.

As an example that the invention is applied to the information processing apparatus other than the printer, the digital integrated apparatus, the receiving unit, the router, the facsimile machine, this embodiment exemplifies the copying machine, but the scope of the application is not limited to these. That is to say, the invention can be applied to any information processing apparatus that is able to output the content in any way.

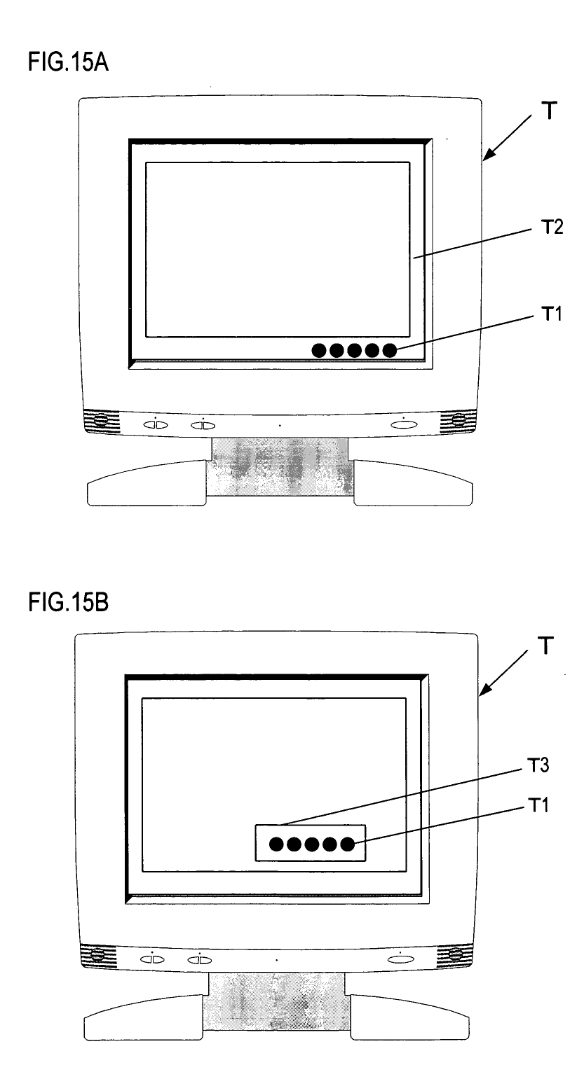

For example, in case of using a digital television T for a viewer of a digital still camera as shown in FIG. 15, the advertisement data can be displayed on a part of the television screen. In this case, the advertisement data T1 may be displayed on the part of the viewer frame T2 as shown in FIG. 15A, or overlaid on an arbitrary area T3 within the viewer as shown in FIG. 15B.

If the digital television is used for the viewer of the digital still camera, the reduction of the printing fee may not be considered. Therefore, in this case, it is preferable to discount the fee necessary for maintaining the digital television (the viewing fee for pay-TV and the Internet providing fee). It is nevertheless to say that the image data taken by the digital still camera corresponds to “the content stored in the client” described in the first to fourth embodiments.

### Embodiment 6

The invention is configured in the first to fourth embodiments that the advertisement data is combined to “the content stored in the client”, but it is not limited to this. That is to say, it is also possible to obtain the same effect by combining the advertisement data to “the secret content stored in the client”.

Provided that the client purchases the right of possession or use of the content stored in a content server on the Internet (the content server is called an “external device of the client”) by the electronic settlement. The content thus purchased is kept in secret from the third persons except the client; therefore, this is also the “secret content of the client”.

The content, which has been stored in the client before, is stored in the content server, and such case may also be the same as above. That is to say, since such stored content is kept in secret from the third persons except the client, it is “the secret content of the client”.

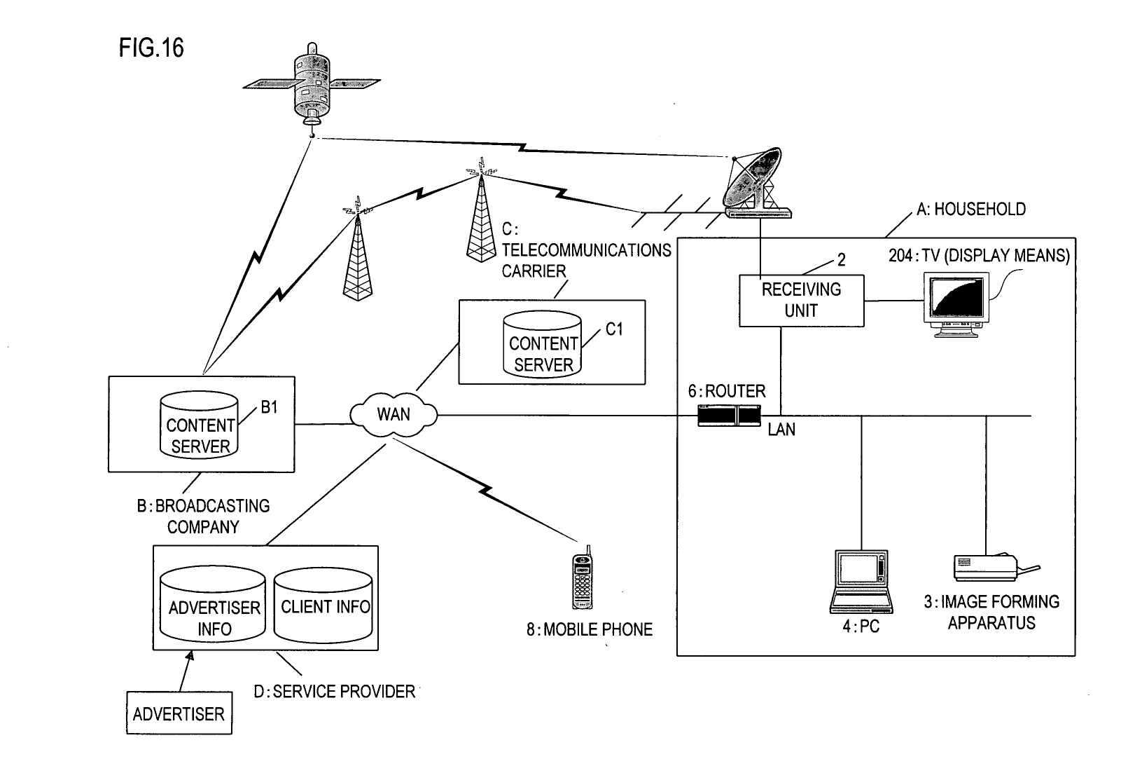

This embodiment of the invention is explained more specifically hereinafter according to FIG. 16. And the “server 1” in the first to fifth embodiments is called a “combine server 1”, in order to be distinguished from the content server, in the following explanation.

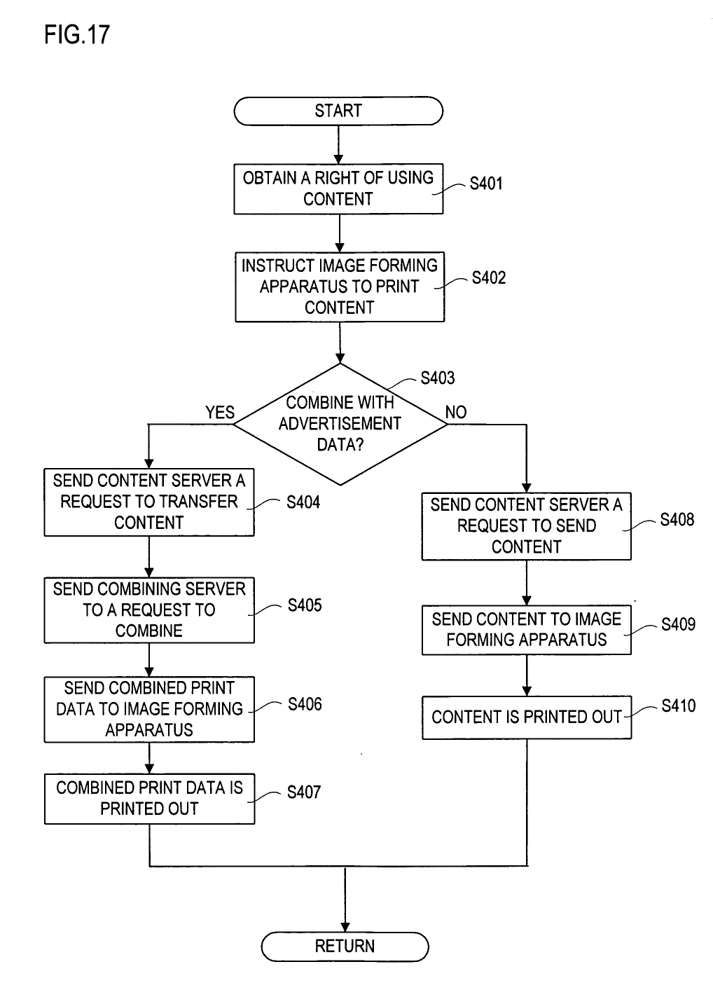

The user of PC 4 browses the content stored in the content server B1 and if there is his favorite content, obtains the right of use (FIG. 17, Step S401). Provided that the content server B1 is provided within the broadcasting company B. But the place to which the content server B1 is provided is not limited in particular. For instance, the content server C1 may be provided within the telecommunications carrier C.

In this case, the acquirement status of the right of using the content must be managed in the content server B1. For this management, the content server B1 may be provided with a table correlating an identifier of the user (or the client) and an identifier of content of which the right of use is assigned to the user.

If the user of PC 4 wants to print the content of which right of use is acquired as above, the print instruction is sent to the image forming apparatus 3 (FIG. 17, Step S402). At this time, the identifier of the content to be printed and the source information of the acquiree are notified from PC 4 to the image forming apparatus 3 together with the print instruction.

The source information of the acquiree represents the acquiree location of the target to be printed. URL (uniform Resource Locator) may be used for the source information, for example.

In response to the print instruction, the image forming apparatus 3 asks the user of PC 4 whether the advertisement data is combined to the content (FIG. 17, Step S403). And in case of receiving from PC 4 a response that the advertisement data is combined to the content, a transfer instruction of the content is sent to the content server B1 (FIG. 17, Step S403: Yes to Step S404).

At receiving the transfer instruction, the content server B1 reads the content from the not-illustrated storage means and sends the combine server 1 a request (combine request) to combine the advertisement data and the content (FIG. 17, Step S405). After receiving the combine request, the combine server 1 combines the content with a proper advertisement data, and sends the combined print data to the image forming apparatus 3 (FIG. 17, Step S406).

In result, the combined print data is printed out by the image forming apparatus 3 (FIG. 17, Step S407), which is the same as described before. And the detailed description is not described here. It is sure that at the printing of the combined print data, the fee reduction points are given to the client as well as the advertisement publication points are given to the advertiser, according to the number of the printing sheets.

On the other hand, when the instruction that the advertisement data is not combined with the content is received from PC 4, the image forming apparatus sends a request (sending request) to send the content toward the content server B1 (FIG. 17, Step S403: No to Step S408). In response to the sending request, the content server B1 reads the content from the not-illustrated storage means and sends the content to the image forming apparatus (FIG. 1, Step S409).

According the above steps, the content is printed out by the image forming apparatus 3 (FIG. 17, Step S410), which was described before, therefore, the details are not described here. Since the advertisement data is not printed out at this time, the fee reduction points are not given to the client and the advertisement publication points are not also given to the advertiser.

As described above, it is possible for the invention of this embodiment that the advertisement data is combined with not only the “content stored in the client” but also the “secret content of the client”. This increases the content to be combined with the advertisement data; therefore, it is possible to increase the user's willingness to print.

Besides, this embodiment exemplifies a case where the user operates PC 4, but the invention is not limited to this. That is to say, the same effect can be obtained by operating the receiving unit 2 and the mobile phone 8.

Additionally, it is configured that the combine server 1 is separated from the content server B1, but the invention is not limited to this. That is to say, these servers may be formed to one unit, in such case it is possible to obtain the same effect.

Moreover, the content stored in the content server B1 on the Internet is taken as an example of the “secret content of the client”, but the invention is not limited to this. That is to say, since the content is kept in secret from the third persons except a specific client (one client or plural clients may be allowed), the content is the “secret content of the client” in this embodiment regardless of the storage status.

The “secret content of the client” is not only the one that is kept in secret in fact. That is to say, even if the secret of the content is leaked to some of the third persons, since the content is subjected to the technical processing required to keep the secret, such content is the “secret content of the client”. P30L3 This embodiment takes it as an example that the content stored in the content server B1 is combined with the advertisement data in the combine server 1. But the invention is not limited to this. That is to say, in case of combining the content stored in the content server B1 and the advertisement data in the client, it is possible to obtain the same effect. The configuration that the content and the advertisement data are combined in the client is basically the same as that in the third embodiment, and accordingly, the details are not described here.

Furthermore, regarding the term, “the right of using the content” in this embodiment, “the right of use” may include at least “the right of printing the content”. Even if the user does not have “the right of browsing the content”, when he has “the right of printing the content”, he may be considered as the user with “the right of using the content”. Besides, the “right of printing the content” may include the right of combining the advertisement data and the content, too.

In the last place, the first to sixth embodiments take it as an example that various instructions are sent to the server 1 from the image forming apparatus instead of a terminal such as PC 4, but the invention is not limited to this. That is to say, it may configure that the terminal such as PC 4 issues various instruction direct to the server 1, and at last only the combined print data or the main print data is sent to the image forming apparatus 3. According to such configuration, if the system is configured by the image forming apparatus to which the invention is not applied (a conventional image forming apparatus), it is possible to obtain the same effect.

As described above, the invention adopts the method of reducing the printing fee by incorporating the advertisement into the printed matter. Therefore, it is nevertheless to say that the advertisement provided through the Internet is printed actively.

And the invention can combine the advertisement data to the main print data stored in the client. This increases the user's willingness to print, and the advertisement provided through the Internet is printed out actively.

It is sure that the printing fee is charged to the advertiser providing the advertisement data to be combined with the main print data. Even in case of charging the printing fee to the advertiser in such way, it is configured that the main print data is printed out being combined with the advertisement data, as result with that the advertiser can obtain the merit that the increase of the advertisement effect can be expected.

1. An information processing apparatus included in a local system of a client connected with a server through the network, which comprising:
a sending means for sending a content stored in the client;
a receiving means for receiving a data wherein an advertisement data is combined with the content; and
an output means for outputting the combined data received by the receiving means.

2. An information processing apparatus included in a local system of a client connected with a server through the network, which comprising:
a receiving means for receiving a data wherein an advertisement data is combined with a secret content of the client; and
an output means for outputting the combined data received by the receiving means.

3. An information processing apparatus included in a local system of a client connected with a server through the network, which comprising:
a receiving means for receiving an advertisement data;
a combining means for combining the advertisement data received by the receiving means and a content stored in the client; and
an output means for outputting the combined data prepared by the combining means.

4. An information processing apparatus included in a local system of a client connected with a server through the network, which comprising:
a receiving means for receiving a secret content of the client and an advertisement data;
a combining means for combining the advertisement data and the content received by the receiving means; and
an output means for outputting the combined data prepared by the combining means.

5. The information processing apparatus according to either one of claims 1 to 4, which comprising:
an inquiry means for inquire of the client whether the advertisement data is combined to the content, and
said apparatus wherein the output means outputs the combined data only when the inquiry means receives from the client a response that the advertisement data is combined to the content.

6. The information processing apparatus according to claim 5, wherein the inquiry means inquires of the client as of the advertisement data to be combined, and the output means outputs the combined data combined with the advertisement data notified from the client to the inquiry means.

7. The information processing apparatus according to claim 3 or 4, wherein the combining means arranges the content in the center of a page, and the advertisement data in the header or the footer of the page

8. The information processing apparatus according to claim 3 or 4, wherein the combining means arranges the content on the front or the back of a page, and the advertisement data on the back or the front of the page.

9. The information processing apparatus according to either one of claims 1 to 4, which further comprising a printer engine for printing the data.

10. The information processing apparatus according to either one of claims 1 to 4, which further comprising a broadcast receiving means for receiving the digital broadcasting.

11. The information processing apparatus according to either one of claims 1 to 4, which further comprising a connecting means for connecting systems or networks of which protocols are different.

12. The information processing apparatus according to claim 3, which further comprising a reading means for preparing the content by reading an original.

13. The information processing apparatus according to claim 2 or 4, wherein the secret content of the client is stored in an external device of the client and the right of using the secret content belongs to the client.

14. A server connected with a client through the network, which comprising:
a storage means for storing an advertisement data;
an extracting means for extracting a proper advertisement data from the storage means;
a receiving means for receiving a content stored in the client or a secret content of the client;
a combining means for combining the advertisement data extracted by the extracting means and the content; and
a sending means for sending the combined data prepared by the combining means.

15. A server connected with a client through the network, which comprising:
a storage means for storing an advertisement data;
an extracting means for extracting a proper advertisement data from the storage means;
a sending means for sending the advertisement data extracted by the extracting means.

16. The server according to claim 14 or 15, which further comprising an inquiry means for inquiring of the client whether the advertisement data is combined to the content, and said server wherein the extracting means extracts a proper advertisement data from the storage means only when the inquiry means receives from the client a response that the advertisement data is combined to the content.

17. The server according to claim 16, wherein the inquiry means inquires of the client as of an advertisement data to be combined, and the extracting means extracts from the storage means the advertisement data notified from the client to the inquiry means.

18. The server according to claim 14, wherein the combining means arranges the content in the center of a page and the advertisement data in the header or the footer of the page.

19. The server according to claim 14, wherein the combining means arranges the content on the front or the back of a page, and the advertisement data on the back or the front of the page.

20. The server according to claim 14, wherein the secret content of the client is stored in an external device of the client and the right of using the secret content belongs to the client.

21. An information processing system which comprising the information processing apparatus according to claim 1 or 2 and the server according to claim 14.

22. An information processing system which comprising the information processing apparatus according to claim 3 or 4 and the server according to claim 15.

23. A method of reducing the printing fee by incorporating an advertisement into printed matters, which comprising steps of:
combining a content stored in a client or a secret content of the client and an advertisement data stored in the server;
giving fee reduction points to the client according to the number of the printing sheets when the combined data is printed out by an information processing apparatus included in a local system of the client; and
providing a user included in the local system with a consumption good for the printing when the fee reduction points become a specific value.

24. The printing fee reduction method according to claim 23, wherein the fee reduction point is given to the client according to the number of the advertisement data included in the combined data instead of the number of the printing sheets.

25. The printing fee reduction method according to claim 23, wherein the consumption good is a marking material adaptive to the information processing apparatus.

26. The printing fee reduction method according to claim 23, which further comprising a step of, when the fee reduction points become a specific value, inquiring of the client whether the fee reduction points is used to redeem the consumption good.

27. The printing fee reduction method according to claim 23, wherein, at the time of printing the combined data by the information processing apparatus included in the local system of the client, an advertisement publication point is given to the advertiser according to the number of the printing sheets and the publication fee according to the advertisement publication points is collected from the advertiser.

28. The printing fee reduction method according to claim 27, wherein the advertisement publication point is given to the advertiser according to the number of the advertisement data included in the combined data instead of the number of the printing sheets.

29. The printing fee reduction method according to claim 23 or 24, wherein the content is prepared after the information processing apparatus reads the original.

30. The printing fee reduction method according to claim 29, wherein, when a user must pay the printing fee as a charge for using the information processing apparatus, the consumption good is not provided to the user included in the local system, and the printing fee charged to the user of the information processing apparatus is reduced.

31. The printing fee reduction method according to claim 23, the secret content of the client is stored in an external device of the client and the right of using the secret content belongs to the client.
